(19) United States
(12) Patent Application Publication
(10) Pub. No.: US 2026/0195931 A1
(43) Pub. Date: Jul. 9, 2026

(54) SYSTEMS AND METHODS FOR CONTEXTUAL GENERATIVE TRANSFORMATIONS

(71) Applicant: Dell Products L.P., Round Rock, TX (US)

(72) Inventors: Erik SUMMA, Lockhart, TX (US); Tyler R. COX, Austin, TX (US); Jason S. MORRISON, Chadron, NE (US)

(73) Assignee: Dell Products L.P., Round Rock, TX (US)

(21) Appl. No.: 19/011,059

(22) Filed: Jan. 6, 2025

(51) Int. Cl. G06T 11/00

(52) U.S. Cl. CPC G06T 11/00; G06T 2211/441

(57) ABSTRACT

An information handling system may include a memory and a processor communicatively coupled to the memory, and configured to receive an input asset from a user and apply one or more comprehension models to the input asset to determine one or more characteristics associated with the input asset. The processor may also be configured to based on the one or more characteristics, place the input asset into one or more virtual mood boards. The processor may further be configured to receive and aggregate contextual information regarding the user and apply a language model to a combination of the one or more virtual mood boards and the contextual information to create one or more generative artificial intelligence prompts.

### TECHNICAL FIELD

The present disclosure relates in general to information handling systems, and more particularly to methods and systems for contextual generative transformations of uploaded assets.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals.

Generative artificial intelligence is a subset of artificial intelligence that uses generative models to produce text, images, videos, or other forms of data in response to specific prompts. Generative artificial intelligence systems learn the underlying patterns and structures of their training data, enabling them to create new data.

Currently, many generative artificial intelligence tools allow a user to generate new images or video. These tools allow a user to type in a prompt to generate content, and many of the tools support a user uploading an image or other digital asset as a point of inspiration to be considered in the output. However, a user typically does not decide what the service pulls from the digital asset - it could be the style, subject matter, color, or some other feature that the user finds interesting in the image. Accordingly, artificial intelligence tools that may infer the characteristics of a digital asset that the user finds meaningful and even create generative prompts from such inferred characteristics may be desirable.

### SUMMARY

In accordance with the teachings of the present disclosure, the disadvantages and problems associated with existing approaches to generative artificial intelligence may be reduced or eliminated.

In accordance with embodiments of the present disclosure, an information handling system may include a memory and a processor communicatively coupled to the memory, and configured to receive an input asset from a user and apply one or more comprehension models to the input asset to determine one or more characteristics associated with the input asset. The processor may also be configured to based on the one or more characteristics, place the input asset into one or more virtual mood boards. The processor may further be configured to receive and aggregate contextual information regarding the user and apply a language model to a combination of the one or more virtual mood boards and the contextual information to create one or more generative artificial intelligence prompts.

In accordance with these and other embodiments of the present disclosure, a method may include receiving an input asset from a user and applying one or more comprehension models to the input asset to determine one or more characteristics associated with the input asset. The method may also include based on the one or more characteristics, placing the input asset into one or more virtual mood boards. The method may further include receiving and aggregating contextual information regarding the user and applying a language model to a combination of the one or more virtual mood boards and the contextual information to create one or more generative artificial intelligence prompts.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to: (i) receive an input asset from a user; (ii) apply one or more comprehension models to the input asset to determine one or more characteristics associated with the input asset; (iii) based on the one or more characteristics, place the input asset into one or more virtual mood boards; (iv) receive and aggregate contextual information regarding the user; and (v) apply a language model to a combination of the one or more virtual mood boards and the contextual information to create one or more generative artificial intelligence prompts.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example artificial intelligence system, in accordance with embodiments of the present disclosure; and

FIG. 2 illustrates a flow chart of an example method for contextual generative transformation, in accordance with embodiments of the present disclosure.

### DETAILED DESCRIPTION

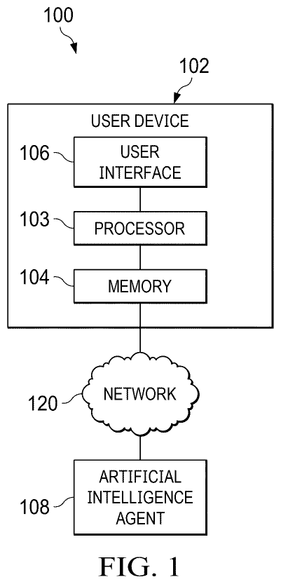

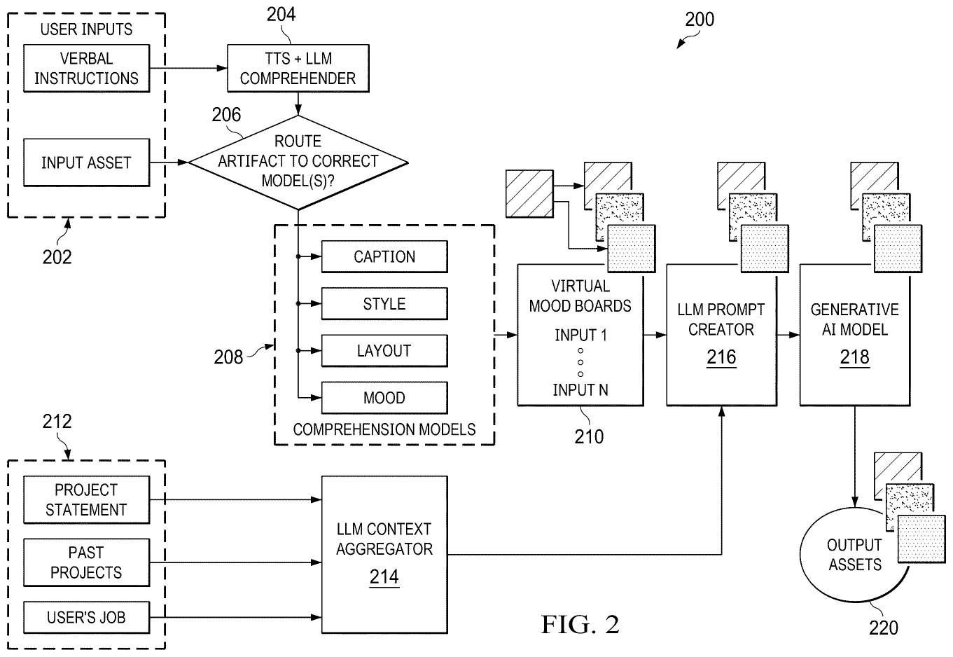

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example artificial intelligence system 100, in accordance with embodiments of the present disclosure. As shown in FIG. 1, artificial intelligence system 100 may include a user device 102, an artificial intelligence agent 108, and a network 120.

User device 102 may comprise an information handling system, as defined above. User device 102 may comprise a smart phone, tablet, personal computer (e.g., a laptop or notebook computer,) or any other suitable device.

As depicted in FIG. 1, user device 102 may include a processor 103, a memory 104 communicatively coupled to processor 103, and a user interface 106 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a user device 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to user device 102 is turned off.

User interface 106 may comprise any instrumentality or aggregation of instrumentalities by which a user may interact with a user device 102. For example, user interface 106 may permit a user to input data and/or instructions into user device 102 (e.g., via a keyboard, pointing device, touchscreen, camera) and/or otherwise manipulate information handling system 102 and its associated components. User interface 106 may also permit information handling system 102 to communicate data to a user, e.g., by way of a display device (e.g., a liquid crystal display), via audible sound (e.g., a speaker or headphone), and/or haptic feedback (e.g., via vibration).

For purposes of clarity and exposition, user device 102 is depicted as only including a processor 103, a memory 104, and a user interface 106. However, user device 102 may comprise other information handling resources not explicitly depicted in FIG. 1.

Artificial intelligence agent 108 may comprise any system, device, or apparatus configured to provide a virtual software agent designed to assist a user with various tasks and provide information using artificial intelligence technologies. In some embodiments, artificial intelligence agent 108 may be configured to performative generative artificial intelligence tasks. In some embodiments, artificial intelligence agent 108 may comprise an information handling system distinct from user device 102 (e.g., may execute on an information handling system “in the cloud” and be communicatively coupled to user device 102 via network 120). In other embodiments, artificial intelligence agent 108 may comprise executable instructions stored within a memory 104 of user device 102, with such instructions configured to be read and executable by processor 103 of such user device 102 in order to carry out the functionality of artificial intelligence agent 108.

Network 120 may comprise a network and/or fabric configured to communicatively couple user device 102 and artificial intelligence agent 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, artificial intelligence agent 108 may be configured to, in addition to functionality discussed above, receive an uploaded digital asset (e.g., such as an image or video) from a user, and based on contextual information associated with the user, infer the characteristics of a digital asset that the user finds meaningful and create generative prompts from such inferred characteristics in order to generate content (e.g., new images and/or videos).

For example, artificial intelligence agent 108 may route content inputted by a user and verbal commentary associated with the inputted content through a series of comprehension models to determine a type, a style, a layout, a mood, and/or other characteristic associated with the inputted content. Artificial intelligence agent 108 may use these comprehension models to place the inputted content into one or more virtual mood boards based on similarities in theme and/or other patterns detected by the comprehension models.

Artificial intelligence agent 108 may employ a parallel input stream from the inputting content to aggregate contextual data regarding the user. For example, aggregated data may include information in a project statement for a project upon which the user is working, past projects associated with a user, the user's job description, and/or other contextual sources. Artificial intelligence agent 108 may apply a large language model to the aggregated contextual information in combination with the one or more virtual mood boards to create one or more generative artificial intelligence prompts to be input into a generative artificial intelligence model. For example, in some embodiments the large language model may generate one or more prompts for each virtual mood board. As a result, a generative artificial intelligence model (which may in some embodiments be implemented by artificial intelligence agent 108) may generate output content based on the one or more prompts.

FIG. 2 illustrates a flow chart of an example method 200 for contextual generative transformation, in accordance with embodiments of the present disclosure. According to some embodiments, method 200 may begin at step 202. As noted above, teachings of the present disclosure may be implemented in a variety of configurations of artificial intelligence system 100. As such, the preferred initialization point for method 200 and the order of the steps comprising method 200 may depend on the implementation chosen.

At step 202, artificial intelligence agent 108 may receive inputs from a user including an input asset (e.g., image, video, etc.) and verbal information or instructions associated with the input asset. At step 204, artificial intelligence agent 108 may apply a text-to-speech (TTS) tool and a large language model (LLM) to comprehend the verbal information. At step 206, artificial intelligence agent 108 may combine and route the processed verbal information and the input asset through one or more comprehension models. At step 208, the one or more comprehension models may determine one or more characteristics (e.g., a type, a style, a layout, a mood) associated with the input asset. At step 210, based on the one or more characteristics, artificial intelligence agent 108 may place the input asset into one or more virtual mood boards based on similarities in theme and/or other patterns detected by the comprehension models.

In parallel with steps 202 to 210, at step 212, artificial intelligence agent 108 may receive contextual data regarding the user. For example, such data may include information in a project statement for a project upon which the user is working, past projects associated with a user, the user's job description, and/or other contextual sources. At step 214, artificial intelligence agent 108 may apply an LLM to aggregate the contextual data.

At step 216, artificial intelligence agent 108 may apply another LLM to the combination of the aggregated contextual information and the one or more virtual mood boards to create one or more generative artificial intelligence prompts (e.g., one or more prompts for each virtual mood board). At step 218, a generative artificial intelligence model (which may in some embodiments be implemented by artificial intelligence agent 108) may generate output assets 220 based on the one or more prompts.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of user environment 100 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
receive an input asset from a user;
apply one or more comprehension models to the input asset to determine one or more characteristics associated with the input asset;
based on the one or more characteristics, place the input asset into one or more virtual mood boards;
receive and aggregate contextual information regarding the user; and
apply a language model to a combination of the one or more virtual mood boards and the contextual information to create one or more generative artificial intelligence prompts.

2. The information handling system of claim 1, wherein the processor is further configured to apply a generative model to the one or more generative artificial intelligence prompts to generate one or more output assets based on the input asset.

3. The information handling system of claim 2, wherein at least one of the one or more output assets comprises an image or video.

4. The information handling system of claim 1, wherein the processor is further configured to:
receive verbal instructions from the user regarding the input asset; and
apply the one or more comprehension models to a combination of the input asset and the verbal instructions to determine one or more characteristics associated with the input asset.

5. The information handling system of claim 1, wherein the input asset comprises an image or video.

6. The information handling system of claim 1, wherein the one or more characteristics comprises one or more of a type, a style, a layout, and a mood associated with the input asset.

7. A method comprising:
receiving an input asset from a user;
applying one or more comprehension models to the input asset to determine one or more characteristics associated with the input asset;
based on the one or more characteristics, placing the input asset into one or more virtual mood boards;
receiving and aggregating contextual information regarding the user; and
applying a language model to a combination of the one or more virtual mood boards and the contextual information to create one or more generative artificial intelligence prompts.

8. The method of claim 7, wherein the processor is further configured to apply a generative model to the one or more generative artificial intelligence prompts to generate one or more output assets based on the input asset.

9. The method of claim 8, wherein at least one of the one or more output assets comprises an image or video.

10. The method of claim 7, wherein the processor is further configured to:
receive verbal instructions from the user regarding the input asset; and
apply the one or more comprehension models to a combination of the input asset and the verbal instructions to determine one or more characteristics associated with the input asset.

11. The method of claim 7, wherein the input asset comprises an image or video.

12. The method of claim 7, wherein the one or more characteristics comprises one or more of a type, a style, a layout, and a mood associated with the input asset.

13. An article of manufacture comprising:
a non-transitory computer-readable medium; and
computer-executable instructions carried on the computer-readable medium, the instructions readable by a processor, the instructions, when read and executed, for causing the processor to:
receive an input asset from a user;
apply one or more comprehension models to the input asset to determine one or more characteristics associated with the input asset;
based on the one or more characteristics, place the input asset into one or more virtual mood boards;
receive and aggregate contextual information regarding the user; and
apply a language model to a combination of the one or more virtual mood boards and the contextual information to create one or more generative artificial intelligence prompts.

14. The article of claim 13, wherein the processor is further configured to apply a generative model to the one or more generative artificial intelligence prompts to generate one or more output assets based on the input asset.

15. The article of claim 14, wherein at least one of the one or more output assets comprises an image or video.

16. The article of claim 13, wherein the processor is further configured to:
receive verbal instructions from the user regarding the input asset; and
apply the one or more comprehension models to a combination of the input asset and the verbal instructions to determine one or more characteristics associated with the input asset.

17. The article of claim 13, wherein the input asset comprises an image or video.

18. The article of claim 13, wherein the one or more characteristics comprises one or more of a type, a style, a layout, and a mood associated with the input asset.
